(19) United States
(12) Patent Application Publication
(10) Pub. No.: US 2013/0194019 A1
(43) Pub. Date: Aug. 1, 2013

(54) SEMICONDUCTOR INTEGRATED CIRCUIT AND METHOD OF OPERATING DEVICE INCLUDING THE SAME

(71) Applicants: Hoi Jin Lee, Seoul (KR); Gun Ok Jung, Yongin-si (KR)

(72) Inventors: Hoi Jin Lee, Seoul (KR); Gun Ok Jung, Yongin-si (KR)

(21) Appl. No.: 13/613,953

(22) Filed: Sep. 13, 2012

(30) Foreign Application Priority Data
Jan. 27, 2012 (KR) 10-2012-0008548

(51) Int. Cl. G06F 1/04

(52) U.S. Cl. 327/297

(57) ABSTRACT

The semiconductor integrated circuit includes a clock tree that transmits a clock signal to a plurality of tree branches, a plurality of pulse generators, and a plurality of pulse distribution networks. Each pulse generator generates a pulse in response to the clock signal transmitted through the tree branches. Each pulse distribution network is in communication with a pulse generator of the plurality of pulse generators, and is constructed and arranged to transmit the pulse generated by each pulse generator to a plurality of pulse sinks.

### CROSS-REFERENCE TO RELATED APPLICATIONS

This application claims priority under 35 U.S.C. §119(a) from Korean Patent Application No. 10-2012-0008548 filed on Jan. 27, 2012, the disclosure of which is hereby incorporated by reference in its entirety.

### BACKGROUND

Embodiments of the inventive concepts relate to a semiconductor integrated circuit (IC), and more particularly, to an IC having a new clock path structure for transmitting a clock signal and a new pulse path structure for transmitting a pulse to reduce power consumption and a method of operating a device including the same.

With the widespread of portable electronic devices such as smart phones and tablet personal computers (PCs) and the increase of applications available in the portable electronic devices, methods of reducing power consumption of the portable devices are desirable.

The portable electronic devices include various synchronizing circuits operating in synchronization with a clock signal. Conventional methods implement clock gating to reduce the power consumption of the synchronizing circuits.

### SUMMARY

In accordance with one aspect, provided is a semiconductor integrated circuit (IC) including a clock tree that transmits a clock signal to a plurality of tree branches; a plurality of pulse generators, each pulse generator generating a pulse in response to the clock signal transmitted through the tree branches; and a plurality of pulse distribution networks, each pulse distribution network in communication with a pulse generator of the plurality of pulse generators, each pulse distribution network constructed and arranged to transmit the pulse generated by each pulse generator to a plurality of pulse sinks.

In an embodiment, each of the pulse sinks includes a sequential logic circuit.

In an embodiment, at least one of the pulse distribution networks has a tree structure.

In an embodiment, at least one of the pulse distribution networks has a mesh structure.

In an embodiment, at least one of the pulse distribution networks has a fan-shaped structure.

In an embodiment, at least one of the pulse distribution networks has a radial-shaped structure.

In an embodiment, at least one of the pulse distribution networks has a polygon structure.

In an embodiment, at least two of the pulse distribution networks have the polygon structure.

In an embodiment, a ratio between a length of a closed polygonal chain of one of the at least two polygon structures and a length of a closed polygonal chain of another one of the at least two polygon structures is (1+α), where −1<α<1.

In an embodiment, at least one of the pulse distribution networks has a ring structure.

In accordance with another aspect, provided is a semiconductor IC including a clock mesh, a plurality of pulse generators, and a plurality of pulse distribution networks. The clock mesh transmits a clock signal to a plurality of mesh branches. Each pulse generator generates a pulse in response to clock signal transmitted through the mesh branches. Each pulse distribution network is in communication with a pulse generator of the plurality of pulse generators, each pulse distribution network constructed and arranged transmit the pulse generated by each pulse generator to a plurality of pulse sinks.

In an embodiment, each of the pulse sinks includes a sequential logic circuit.

In an embodiment, at least one of the pulse distribution networks has a one of a tree structure, a mesh structure, a fan-shaped structure, a radial-shaped structure, a polygon structure, and a ring structure.

In an embodiment, at least two of the pulse distribution networks have a polygon structure, and a ratio between a length of a closed polygonal chain of one of the at least two polygon structures and a length of a closed polygonal chain of another one of the at least two polygon structures is (1+α), where −1<α<1.

In another aspect, provided is a method of operating a data processing device, comprising: transmitting a clock signal to a plurality of tree branches of a clock tree; generating, by each pulse generator of a plurality of pulse generators, a pulse in response to the clock signal transmitted through each of the tree branches; transmitting the pulse generated from a pulse generator of the plurality of pulse generators to a plurality of pulse sinks, the plurality of pulse sinks connected to a pulse distribution network of a plurality of pulse distribution networks; and processing data output from a data source in response to the pulse using the pulse sinks.

In an embodiment, at least one of the pulse distribution networks has one of a tree structure, a mesh structure, a fan-shaped structure, a radial-shaped structure, a polygon structure, and a ring structure.

In an embodiment, each of the pulse sinks includes a sequential logic circuit.

In an embodiment, the data processing device is one of a system on chip, a processor, a central processing unit, a personal computer, a data server, and a portable device.

In another aspect, provided is method of operating a data processing device, the method comprising: transmitting a clock signal to a plurality of mesh branches of a clock mesh; generating, by each pulse generator of a plurality of pulse generators, a pulse in response to the clock signal transmitted through each of the mesh branches; transmitting the pulse generated from a pulse generator of the plurality of pulse generators to a plurality of pulse sinks, the plurality of pulse sinks connected to a pulse distribution network of a plurality of pulse distribution networks; and processing data output from a data source in response to the pulse using the pulse sinks.

In an embodiment, at least one of the pulse distribution networks has one of a tree structure, a mesh structure, a fan-shaped structure, a radial-shaped structure, a polygon structure, and a ring structure.

In an embodiment, the data processing device is one of a system on chip, a processor, a central processing unit, a personal computer, a data server, and a portable device.

In another aspect, provided is a semiconductor integrated circuit (IC), comprising: a clock distribution network, a plurality of pulse generators coupled to the clock distribution network, wherein a pulse generator of the plurality of pulse generators generates a pulse signal in response to the clock signal transmitted through the clock distribution network; and a plurality of pulse distribution networks in communication with the plurality of pulse generators, a pulse distribution network of the plurality of pulse distribution networks constructed and arranged to transmit the pulse signal generated by the pulse generator to a plurality of pulse sinks.

In an embodiment, the semiconductor IC further comprises a clock source that provides the clock to the clock distribution network.

In an embodiment, each of the pulse sinks includes a sequential logic circuit.

In an embodiment, the sequential logic circuit processes input data based on the pulse signal.

In an embodiment, at least one of the plurality of pulse distribution networks has one of a tree structure, a mesh structure, a fan-shaped structure, a radial-shaped structure, a polygon structure, and a ring structure.

In an embodiment, the clock distribution network includes a plurality of tree branches, the pulse generator of the plurality of pulse generators is coupled to at least one tree branch of the plurality of tree branches, and the clock signal is output to the at least one tree branch to the pulse generator.

In an embodiment, the clock distribution network includes a clock mesh having a plurality of mesh branches, the pulse generator of the plurality of pulse generators is coupled to at least one mesh branch of the plurality of mesh branches, and the clock signal is output to the plurality of mesh branches to the pulse generator.

### BRIEF DESCRIPTION OF THE DRAWINGS

The above and other features and advantages of the inventive concept will become more apparent by describing in detail exemplary embodiments thereof with reference to the attached drawings in which:

FIG. 1 is a diagram of the layout of a semiconductor integrated circuit (IC) according to embodiments of the inventive concepts;

FIG. 2 is a diagram of a pulse distribution network (PDN) having a tree structure according to embodiments of the inventive concepts;

FIG. 3 is a diagram of a pulse generator (PG) illustrated in FIG. 1;

FIG. 4 is a diagram of a sequential logic circuit illustrated in FIG. 2;

FIG. 5A is a diagram of a PDN having a mesh structure according to embodiments of the inventive concepts;

FIG. 5B is a diagram of a PDN having a mesh structure according to other embodiments of the inventive concepts;

FIG. 6 is a diagram of a PDN having a fan-shaped structure according to embodiments of the inventive concepts;

FIG. 7 is a diagram of a PDN having a radial-shaped structure according to embodiments of the inventive concepts;

FIG. 8A is a diagram of a PDN having a ring/polygon structure according to embodiments of the inventive concepts;

FIG. 8B is a diagram of a PDN having a ring/polygon structure according to embodiments of the inventive concepts;

FIG. 9 is a diagram of the layout of a semiconductor IC according to other embodiments of the inventive concept;

FIG. 10 is a flowchart of a method of operating a data processing device including the semiconductor IC illustrated in FIG. 1;

FIG. 11 is a flowchart of a method of operating a data processing device including the semiconductor IC illustrated in FIG. 9;

FIG. 12 is a schematic block diagram of a data processing device including the semiconductor IC illustrated in FIG. 1 or 9 according to some embodiments of the inventive concept;

FIG. 13 is a schematic block diagram of a data processing device including a semiconductor IC according to other embodiments of the inventive concept; and

FIG. 14 is a schematic block diagram of a data processing device including a semiconductor IC according to embodiments of the inventive concept.

### DETAILED DESCRIPTION

The inventive concept now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

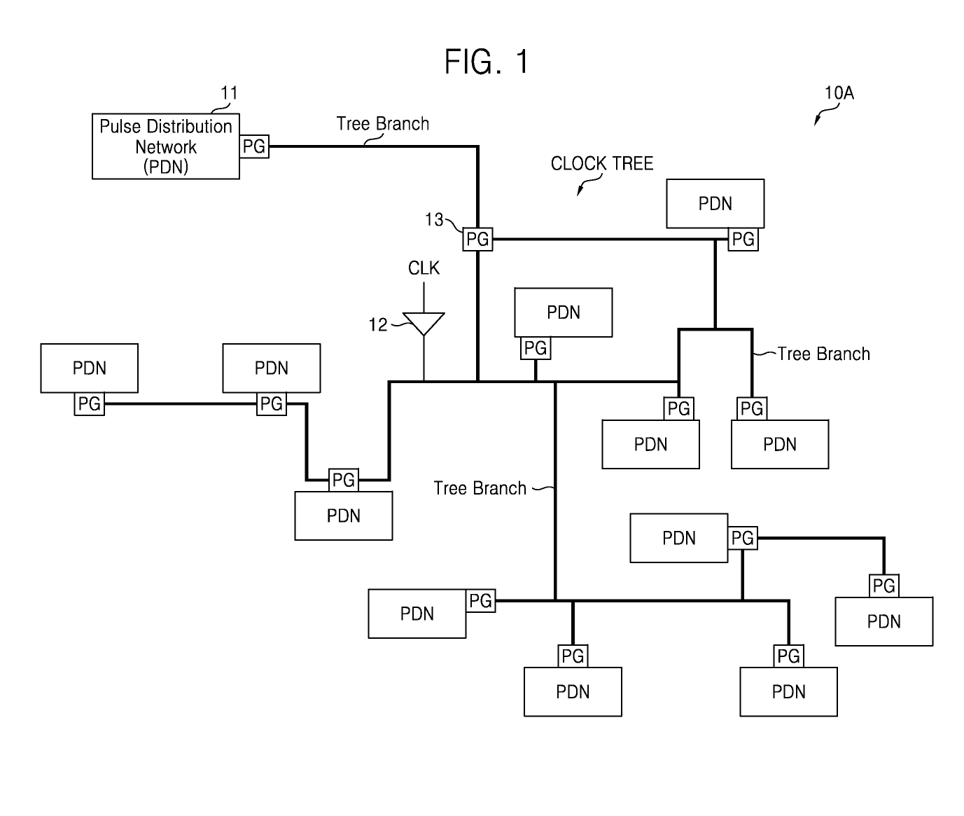

FIG. 1 is a diagram of the layout of a semiconductor integrated circuit (IC) 10A according to embodiments of the inventive concept. The semiconductor IC 10A includes a clock tree including a plurality of tree branches, a plurality of pulse generators (PGs) 13, and a plurality of pulse distribution networks (PDNs) 11.

The semiconductor IC 10A may also include at least one clock buffer 12 coupled between PGs 13. The clock buffer 12 may buffer a clock signal CLK output from a clock source, e.g., a phase-locked loop (PLL), and transmit the buffered clock signal to the clock tree.

The clock tree may transmit the clock signal CLK and/or the buffered clock signal to the plurality of tree branches. Hereinafter, for convenience' sake in the description, the clock signal and/or the buffered clock signal is referred to as a clock signal CLK. The clock tree may be referred to as a clock distribution network.

Each of the PGs 13 can generate a pulse in response the clock signal CLK transmitted through a corresponding one of the tree branches. The PDNs 11 may transmit a pulse output from one or more PGs 13 to one or more different pulse sinks in communication with, or part of, the PDNs 11.

Although it is illustrated that the PGs 13 are external with respect to the PDNs 11 in FIG. 1, each PG may be implemented within a PDN 11A, 11B, 11C, 11D, 11E, 11F, or 11G in other embodiments.

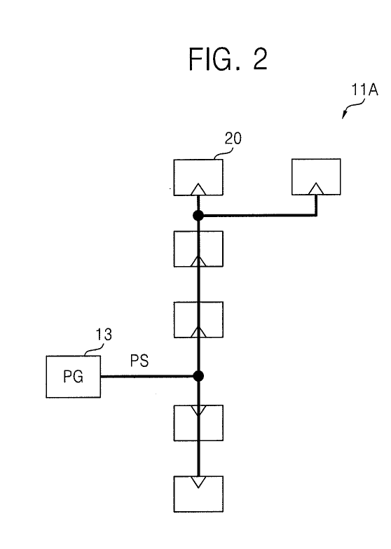

Each of the pulse sinks may be implemented by a sequential logic circuit operating in response to a pulse, for example, a logic circuit 20 shown in FIG. 2. The sequential logic circuit may be implemented using a register, a latch, or a flip-flop. The tree branches can include clock paths that transmit the clock signal CLK to the PGs 13, respectively.

FIG. 2 is a diagram of a PDN 11A having a tree structure, in accordance with an embodiment. In describing the PDN 11A, reference is made to the PDN 11 of FIG. 1. At least one of the PDNs 11 illustrated in FIG. 1 may have a tree structure. Thus, the PDN 11A illustrated in FIG. 2 includes a plurality of sequential logic circuits 20 that may serve as a pulse sink, and may operate in response to a pulse PS generated by a PG 13. The sequential logic circuits 20 may process input data based on the pulse PS.

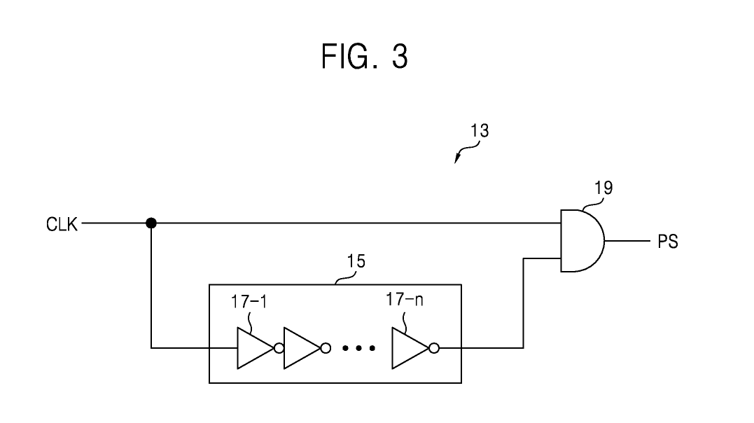

FIG. 3 is a diagram of the PG 13 illustrated in FIGS. 1 and 2. The PG 13 can include an inverter chain 15, including an input terminal that receives a clock signal CLK transmitted through the tree branch. The PG 13 can also include an AND gate 19 that performs an AND operation on the clock signal CLK and an output signal of the inverter chain 15 and outputs a pulse PS. The inverter chain 15 preferably includes an odd number of inverters 17-1 through 17-n connected in series, where “n” is an odd natural number.

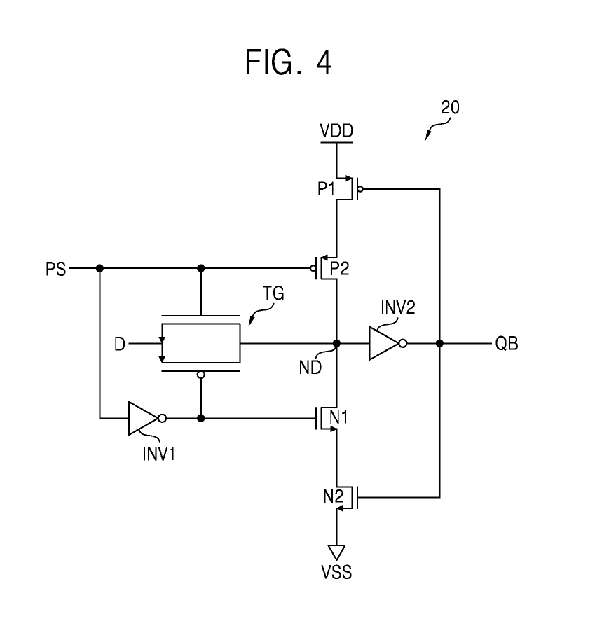

FIG. 4 is a diagram of a sequential logic circuit 20 illustrated in FIG. 2. Referring to FIG. 4, when the pulse PS has a first value, e.g., a high level, the sequential logic circuit 20 outputs inverted data QB. When the pulse PS has a second value, e.g., a low level, the sequential logic circuit 20 maintains previous data.

The sequential logic circuit 20 includes a plurality of P-type metal oxide semiconductor (PMOS) transistors P1 and P2 connected in series between a power node supplying a power supply voltage VDD and a node ND, a plurality of N-type MOS (NMOS) transistors N1 and N2 connected in series between the node ND and a ground VSS, a transfer gate TG, and a plurality of inverters INV1 and INV2.

The transfer gate TG is coupled between a gate of the PMOS transistor P2 and a gate of the NMOS transistor N1, and controls the transmission of data D to the node ND in response to the pulse PS and an output signal of the first inverter INV1. An output terminal of the second inverter INV2 inverts a signal provided at the node ND, which is connected to drains of the transistors P1 and N2, respectively.

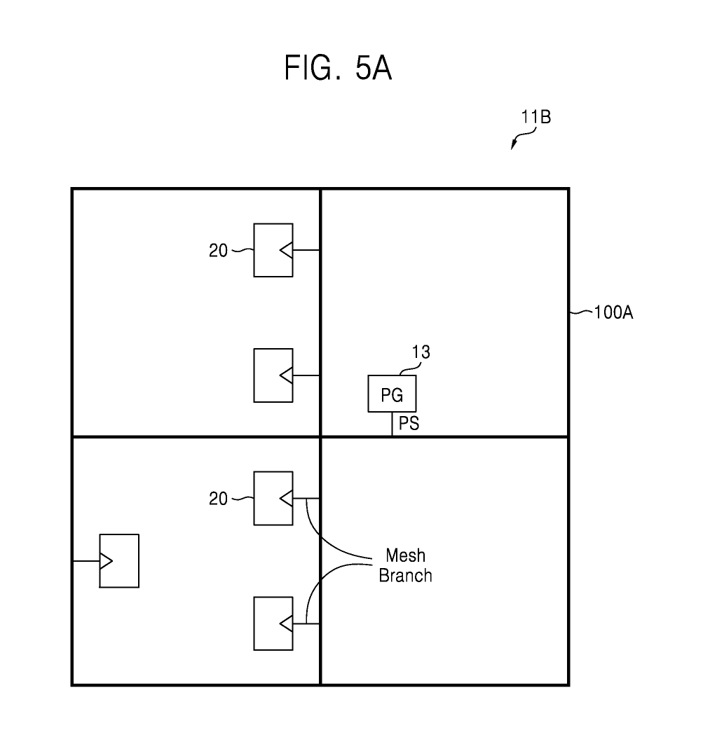

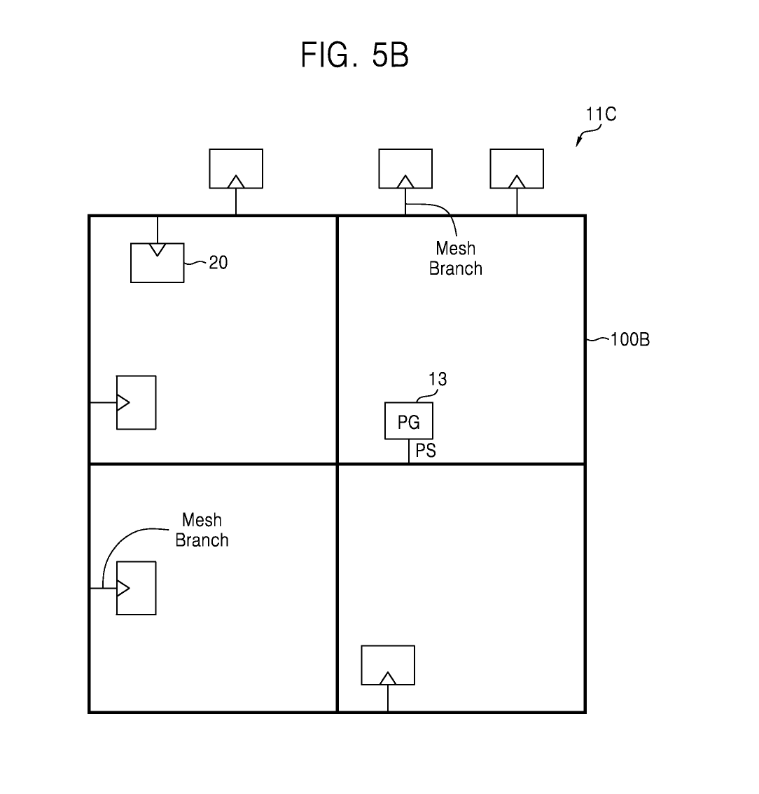

FIG. 5A is a diagram of a PDN 11B having a mesh structure 100A, in accordance with an embodiment. In describing the PDN 11B, reference is made to FIG. 1. For example, at least one of the PDNs 11 illustrated in FIG. 1 may have the mesh structure 100A. The PDN 11B having the mesh structure 100A may include a plurality of the sequential logic circuits 20 that operate in response to the pulse PS generated by a PG 13. Each of the sequential logic circuits 20 may be connected to a corresponding one of a plurality of mesh branches used to transmit the pulse PS.

FIG. 5B is a diagram of a PDN 11C having a mesh structure 100B, in accordance with an embodiment. In describing the PDN 11C, reference is made to FIG. 1. For example, at least one of the PDNs 11 illustrated in FIG. 1 may have the mesh structure 100B. The PDN 11C having the mesh structure 100B may include a plurality of the sequential logic circuits 20 that operate in response to the pulse PS generated by the PG 13. Each of the sequential logic circuits 20 may be connected to a corresponding one of a plurality of mesh branches used to transmit the pulse PS. One or more sequential logic circuits 20 can be external to mesh structure 100B and coupled to the mesh structure 100B by a mesh branch.

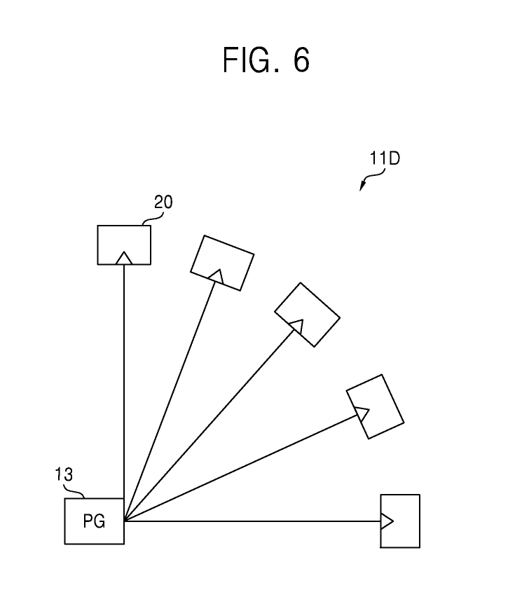

FIG. 6 is a diagram of a PDN 11D having a fan-shaped structure. In describing the PDN 11D, reference is made to FIG. 1. At least one of the PDNs 11 illustrated in FIG. 1 may have a fan-shaped structure. The PDN 11D having the fan-shaped structure may include a plurality of sequential logic circuits 20 that operate in response to a pulse PS generated by a PG 13.

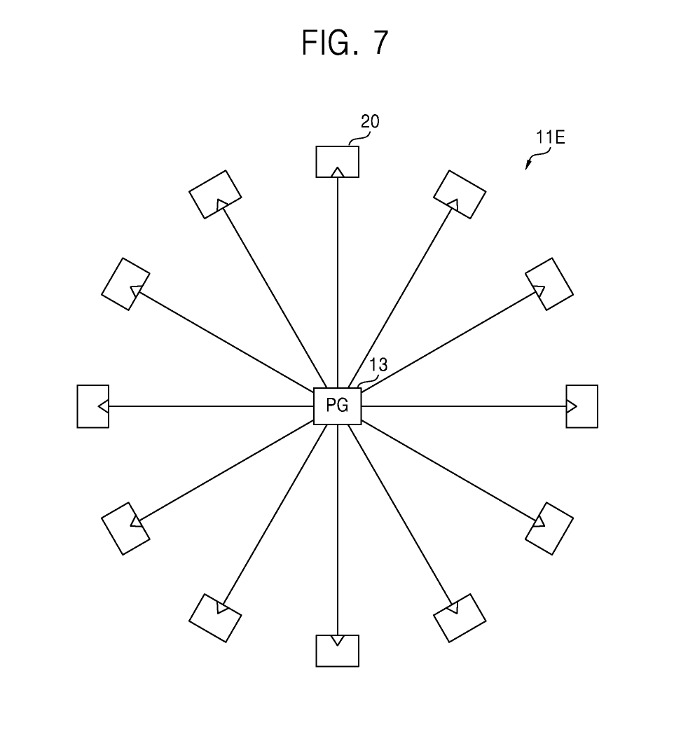

FIG. 7 is a diagram of a PDN 11E having a radial-shaped structure. In describing the PDN 11E, reference is made to FIG. 1. At least one of the PDNs 11 illustrated in FIG. 1 may have a radial-shaped structure. The PDN 11E having the radial-shaped structure may include a plurality of sequential logic circuits 20 coupled to a PG 13 that operate in response to a pulse PS generated by the PG 13.

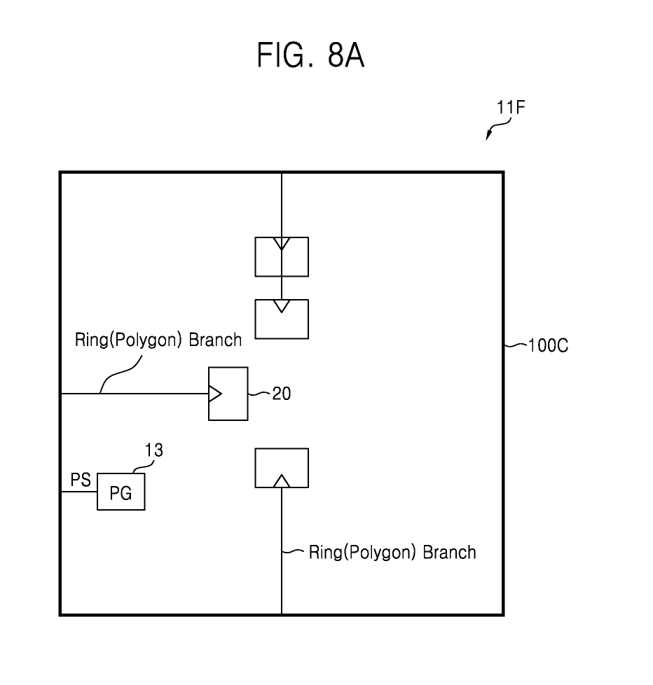

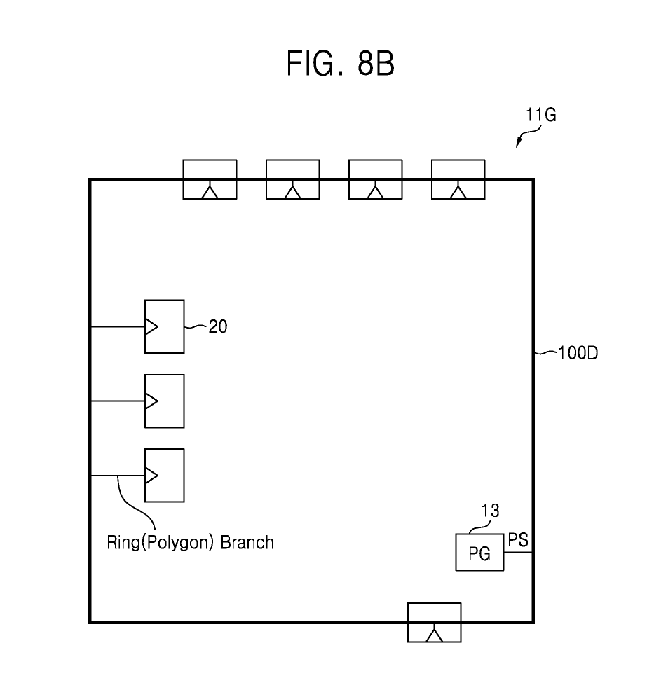

FIG. 8A is a diagram of a PDN 11F having a ring/polygon structure 100C. In describing the PDN 11F, reference is made to FIG. 1. At least one of the PDNs 11 illustrated in FIG. 1 may have the ring/polygon structure 100C. The PDN 11F having the ring/polygon structure 100C may include a plurality of the sequential logic circuits 20 that operate in response to a pulse PS generated by the PG 13. Each of the sequential logic circuits 20 may be connected to a corresponding one of a plurality of, for example, ring branches, also referred to as polygon branches.

FIG. 8B is a diagram of a PDN 11G having a ring/polygon structure 100D. In describing the PDN 11G, reference is made to FIG. 1. At least one of the PDNs 11 illustrated in FIG. 1 may have the ring/polygon structure 100D. The PDN 11G having the ring/polygon structure 100D may include a plurality of the sequential logic circuits 20 that operate in response to the pulse PS generated by the PG 13. Each of the sequential logic circuits 20 may be connected to a corresponding one of a plurality of, for example, ring branches.

For convenience' sake in the description, it is illustrated in FIG. 2 and FIGS. 5A through 8B that the PG 13 is included within a perimeter of the PDNs 11A through 11G, but as described above with reference to FIG. 1, the PG 13 may be implemented outside the PDNs 11A through 11G and coupled to elements of the PDNs 11A through 11G by a branch, for example, a tree branch.

A tree structure as illustrated in FIG. 2, a mesh structure as illustrated in FIG. 5A or 5B, a fan-shaped structure as illustrated in FIG. 6, a radial-shaped structure as illustrated in FIG. 7 and a ring/polygon structure as illustrated in FIG. 8A or 8B are named after the shape of the layout or routing of a pulse path through which the pulse PS is transmitted. The inventive concept is not restricted to those structures. Each of the branches is connected to a control terminal of the PG 13 to which the pulse PS is input in the PDNs 11A through 11G.

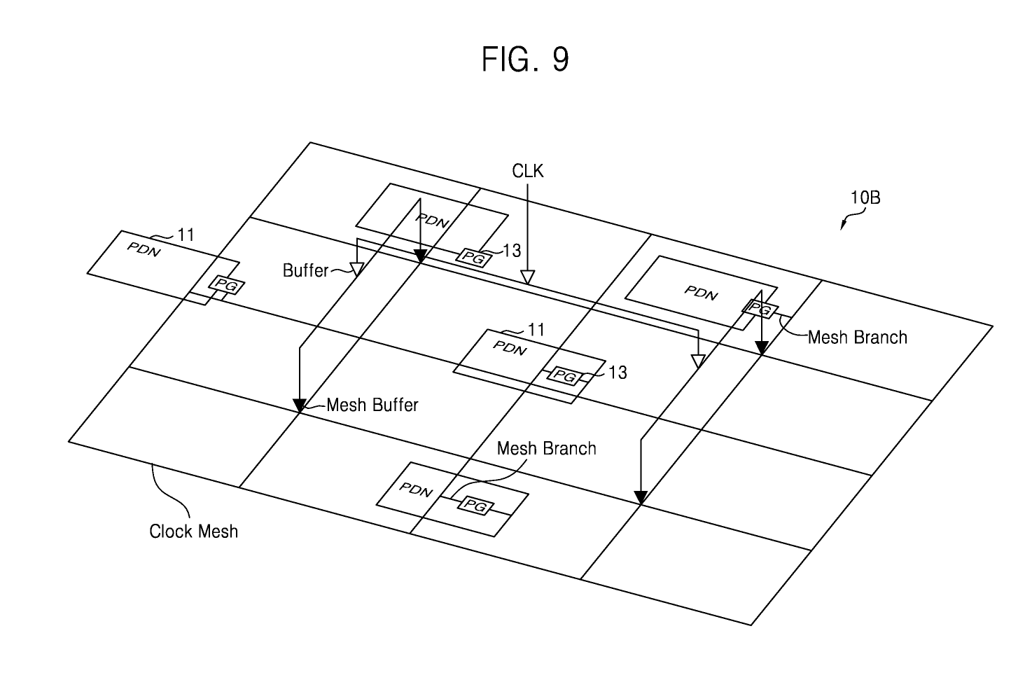

FIG. 9 is a diagram of the layout of a semiconductor IC 10B according to other embodiments of the inventive concept. Referring to FIGS. 1 and 9, the tree structure for transmitting the clock signal CLK in the embodiments illustrated in FIG. 1 can be changed into a mesh structure in the embodiments illustrated in FIG. 9.

Referring to FIG. 9, the semiconductor IC 10B includes a clock mesh including a plurality of mesh branches, a plurality of the PGs 13, and a plurality of the PDNs 11. A mesh may refer to a uniform rectangular grid of conductive wires.

The semiconductor IC 10B may also include at least one mesh buffer, which buffers a clock signal CLK output from a clock source, e.g., a PLL, and transmits a buffered clock signal to the clock mesh, and a clock buffer, which transmits the clock signal CLK to the at least one mesh buffer.

The clock mesh may transmit the clock signal CLK or the buffered clock signal to the plurality of mesh branches.

Each of the PGs 13 can generate a pulse at a PDN II using the clock signal CLK transmitted through a mesh branch. The PDNs 11 may transmit a pulse output from PGs 13 to different pulse sinks, respectively. As described above, each of the pulse sinks may be implemented by a sequential logic circuit, for example, circuits 20 described at FIGS. 2-8. The sequential logic circuit may be implemented using a register, a latch, or a flip-flop. The mesh branches can include clock paths to transmit a clock signal CLK to one or more PGs 13.

As described above with reference to FIG. 2, at least one of the PDNs 11 illustrated in FIG. 9 may have the tree structure.

As described above with reference to FIGS. 5A and 5B, at least one of the PDNs 11 illustrated in FIG. 9 may have the mesh structure 100A or 100B. As described above with reference to FIG. 6, at least one of the PDNs 11 illustrated in FIG. 9 may have the fan-shaped structure. As described above with reference to FIG. 7, at least one of the PDNs 11 illustrated in FIG. 9 may have the radial-shaped structure. As described above with reference to FIGS. 8A and 8B, at least one of the PDNs 11 illustrated in FIG. 9 may have the ring/polygon structure 100C or 100D.

As described above with reference to FIGS. 1 through 9, when the semiconductor IC 10A or 10B (collectively 10) includes a plurality of the PDNs 11A, 11B, 11C, 11D, 11E, 11F, or 11G (collectively 11), a relative ratio between the lengths of total line segments in each PDN 11 may be (1+α), where α is a real number and −1<α<1.

For instance, when the PDNs 11 have at least two polygon structures, e.g., 100C or 100D, the ratio between the length of a closed polygonal chain of one of the polygon structures and the length of a closed polygonal chain of another one of the polygon structures may be (1+α).

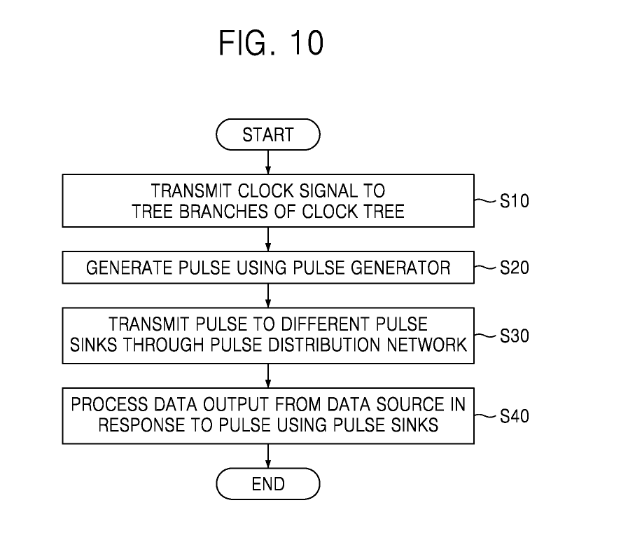

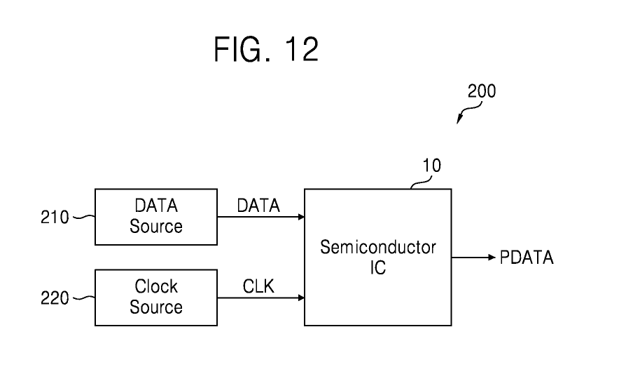

FIG. 10 is a flowchart of a method of operating a data processing device including the semiconductor IC 10 illustrated in FIG. 1. FIG. 12 is a schematic block diagram of a data processing device 200 including the semiconductor IC 10 illustrated in FIG. 1 or 9 according to some embodiments of the inventive concept.

Referring to FIGS. 10 and 12, the data processing device 200 includes the semiconductor IC 10, a data source 210, and a clock source 220. The data processing device 200 refers to any device that includes a sequential logic circuit capable of process data output from the data source 210 in response to the clock signal CLK or the pulse PS generated using the clock signal CLK. For instance, the data processing device 200 may be a system on chip (SoC), a processor, a central processing unit (CPU), a person computer (PC), a data server, or a portable device. The portable device may be a laptop computer, a cellular phone, smart phone, a table PC, a personal digital assistant (PDA), an enterprise digital assistant (EDA), a digital still camera, a digital video camera, a portable multimedia player (PMP), a personal navigation device or portable navigation device (PND), a car navigation system, a handheld game console, or a handheld device such as an e-book.

The semiconductor IC 10 transmits the clock signal CLK output from the clock source 220 or a clock signal buffered by a buffer, for example, clock buffer 12 shown in FIG. 1, to one or more tree branches of a clock tree in operation S10. Each of the PGs 13 included in the semiconductor IC 10 can generate a pulse PS using the clock signal CLK received from the one or more tree branches in operation S20. The pulse PS output from each PG 13 can be transmitted to different pulse sinks 20 connected to a corresponding one of the PDNs 11 in operation S30. Each of the pulse sinks 20 can process data DATA output from the data source 210 in response to the pulse PS and outputs processed data PDATA in operation S40.

As described above with reference to FIG. 2, 5A, 5B, 6, 7, 8A, or 8B, at least one of the PDNs 11 may have a tree structure, a mesh structure, a fan-shaped structure, a radial-shaped structure, a polygon structure, or a ring structure.

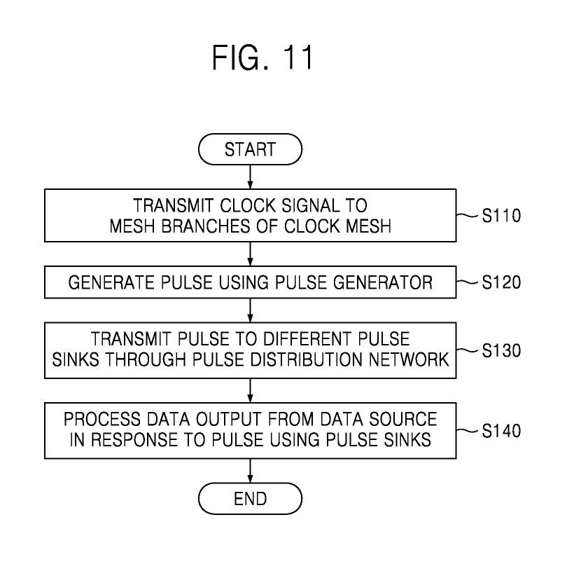

FIG. 11 is a flowchart of a method of operating the data processing device 200 including the semiconductor IC 10 illustrated in FIG. 9. Referring to FIGS. 9, 11, and 12, the semiconductor IC 10 transmits the clock signal CLK output from the clock source 220 or a clock signal buffered by a buffer, for example, clock buffer 12 shown in FIG. 1, to mesh branches of a clock mesh in operation S110.

Each of the PGs 13 included in the semiconductor IC 10 generates a pulse PS using a clock signal CLK received from a corresponding one of the mesh branches in operation S120. The pulse PS output from each PG 13 is transmitted to the different pulse sinks 20 connected to a corresponding one of the PDNs 11 in operation S130. Each of the pulse sinks 20 processes data DATA output from the data source 210 in response to the pulse PS and outputs processed data PDATA in operation S140.

As described above with reference to FIG. 2, 5A, 5B, 6, 7, 8A, or 8B, at least one of the PDNs 11 may have a tree structure, a mesh structure, a fan-shaped structure, a radial-shaped structure, a polygon structure, or a ring structure.

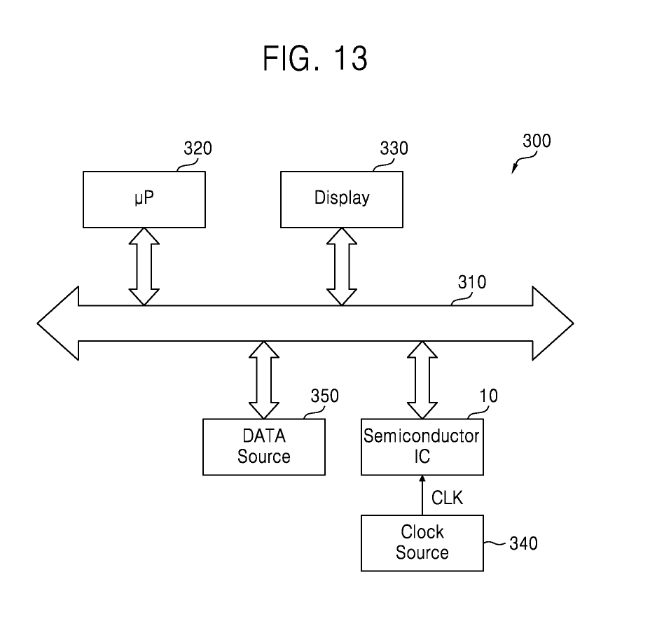

FIG. 13 is a schematic block diagram of a data processing device 300 including the semiconductor IC 10 illustrated in FIG. 1 or 9 according to other embodiments of the inventive concept.

Referring to FIG. 13, the data processing device 300 includes the semiconductor IC 10, a microprocessor 320, a display 330, and a data source 350, which communicate with one another via a bus 310. The data source 350 may be an internal or external memory. The data processing device 300 also includes a clock source 340 generating the clock signal CLK. As described above, the data processing device 300 may be implemented as a PC, a data server, or a portable device.

The clock source 340 illustrated in FIG. 13 can perform the same or similar functions as the clock source 220 illustrated in FIG. 12. The data source 350 illustrated in FIG. 13 can perform the same or similar functions as the data source 210 illustrated in FIG. 12. Details regarding the clock source 340 and the data source 350 therefore not be repeated for brevity.

As described above, a plurality of sequential logic circuits implemented in a semiconductor IC according to some embodiments of the inventive concept process data in response a pulse having a width much narrower than an activation width of a clock signal, so that power consumption of the semiconductor IC is significantly reduced.

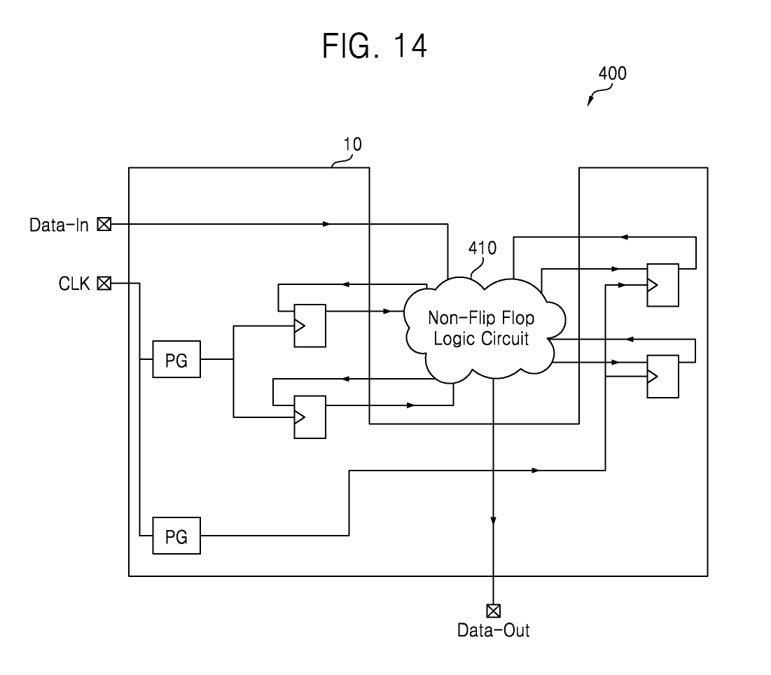

FIG. 14 is a schematic block diagram of a data processing device 400 including the semiconductor IC 10 illustrated in FIG. 1 or 9 according to further embodiments of the inventive concept.

Referring to FIGS. 1, 9, and 14, the data processing device 400 may be implemented by a single IC or a single SoC. The data processing device 400 includes the semiconductor IC 10 and a logic circuit 410. The logic circuit 410 may be implemented by a volatile or non-volatile memory.

Logic circuits constructed and arranged as pulse sinks can be implemented in the semiconductor IC 10, and may communicate data with the logic circuit 410. Input data Data-In may be processed by the semiconductor IC 10 and the logic circuit 410 and then output as output data Data-Out.

According to some embodiments of the inventive concepts, a semiconductor IC uses a new clock path structure for transmitting a clock signal and a new pulse path structure for transmitting a pulse generated using the clock signal, thereby reducing power consumption. Since the power consumption of the semiconductor IC is reduced, power consumption of a data processing device including the semiconductor IC is also reduced.

While the inventive concept has been particularly shown and described with reference to exemplary embodiments thereof, it will be understood by those of ordinary skill in the art that various changes in forms and details may be made therein without departing from the spirit and scope of the inventive concept as defined by the following claims.

What is claimed is:

1. A semiconductor integrated circuit (IC) comprising:
a clock tree that transmits a clock signal to a plurality of tree branches;
a plurality of pulse generators , each pulse generator generating a pulse in response to the clock signal transmitted through the tree branches; and
a plurality of pulse distribution networks, each pulse distribution network in communication with a pulse generator of the plurality of pulse generators, each pulse distribution network constructed and arranged to transmit the pulse generated by each pulse generator to a plurality of pulse sinks.

2. The semiconductor IC of claim 1, wherein each of the pulse sinks includes a sequential logic circuit.

3. The semiconductor IC of claim 1, wherein at least one of the pulse distribution networks has a tree structure.

4. The semiconductor IC of claim 1, wherein at least one of the pulse distribution networks has a mesh structure.

5. The semiconductor IC of claim 1, wherein at least one of the pulse distribution networks has a fan-shaped structure.

6. The semiconductor IC of claim 1, wherein at least one of the pulse distribution networks has a radial-shaped structure.

7. The semiconductor IC of claim 1, wherein at least one of the pulse distribution networks has a polygon structure.

8. The semiconductor IC of claim 7, wherein at least two of the pulse distribution networks have the polygon structure, and
a ratio between a length of a closed polygonal chain of one of the at least two polygon structures and a length of a closed polygonal chain of another one of the at least two polygon structures is (1+α), where −1<α<1.

9. The semiconductor IC of claim 1, wherein at least one of the pulse distribution networks has a ring structure.

10. A semiconductor integrated circuit (IC) comprising:
a clock mesh that transmits a clock signal to a plurality of mesh branches;
a plurality of pulse generators, each pulse generator generating a pulse in response to clock signal transmitted through the mesh branches; and
a plurality of pulse distribution networks, each pulse distribution network in communication with a pulse generator of the plurality of pulse generators, each pulse distribution network constructed and arranged transmit the pulse generated by each pulse generator to a plurality of pulse sinks.

11. The semiconductor IC of claim 10, wherein each of the pulse sinks includes a sequential logic circuit.

12. The semiconductor IC of claim 10, wherein at least one of the pulse distribution networks has a one of a tree structure, a mesh structure, a fan-shaped structure, a radial-shaped structure, a polygon structure, and a ring structure.

13. The semiconductor IC of claim 10, wherein at least two of the pulse distribution networks have a polygon structure, and
a ratio between a length of a closed polygonal chain of one of the at least two polygon structures and a length of a closed polygonal chain of another one of the at least two polygon structures is (1+α), where −1<α<1.

14. A method of operating a data processing device, the method comprising:
transmitting a clock signal to a plurality of tree branches of a clock tree;
generating, by each pulse generator of a plurality of pulse generators, a pulse in response to the clock signal transmitted through each of the tree branches;
transmitting the pulse generated from a pulse generator of the plurality of pulse generators to a plurality of pulse sinks, the plurality of pulse sinks connected to a pulse distribution network of a plurality of pulse distribution networks; and
processing data output from a data source in response to the pulse using the pulse sinks.

15. The method of claim 14, wherein at least one of the pulse distribution networks has one of a tree structure, a mesh structure, a fan-shaped structure, a radial-shaped structure, a polygon structure, and a ring structure.

16. The method of claim 14, wherein each of the pulse sinks includes a sequential logic circuit.

17. The method of claim 14, wherein the data processing device is one of a system on chip, a processor, a central processing unit, a personal computer, a data server, and a portable device.

18. A method of operating a data processing device, the method comprising:
transmitting a clock signal to a plurality of mesh branches of a clock mesh;
generating, by each pulse generator of a plurality of pulse generators, a pulse in response to the clock signal transmitted through each of the mesh branches;
transmitting the pulse generated from a pulse generator of the plurality of pulse generators to a plurality of pulse sinks, the plurality of pulse sinks connected to a pulse distribution network of a plurality of pulse distribution networks; and
processing data output from a data source in response to the pulse using the pulse sinks.

19. The method of claim 18, wherein at least one of the pulse distribution networks has one of a tree structure, a mesh structure, a fan-shaped structure, a radial-shaped structure, a polygon structure, and a ring structure.

20. The method of claim 18, wherein the data processing device is one of a system on chip, a processor, a central processing unit, a personal computer, a data server, and a portable device.

21. A semiconductor integrated circuit (IC), comprising:
a clock distribution network, a clock signal transmitted through the clock distribution network;
a plurality of pulse generators coupled to the clock distribution network, wherein a pulse generator of the plurality of pulse generators generates a pulse signal in response to the clock signal transmitted through the clock distribution network; and
a plurality of pulse distribution networks in communication with the plurality of pulse generators, a pulse distribution network of the plurality of pulse distribution networks constructed and arranged to transmit the pulse signal generated by the pulse generator to a plurality of pulse sinks.

22. The semiconductor IC of claim 21, further comprising:
a clock source that provides the clock to the clock distribution network.

23. The semiconductor IC of claim 21, wherein each of the pulse sinks includes a sequential logic circuit.

24. The semiconductor IC of claim 23, wherein the sequential logic circuit processes input data based on the pulse signal.

25. The semiconductor IC of claim 21, wherein at least one of the plurality of pulse distribution networks has one of a tree structure, a mesh structure, a fan-shaped structure, a radial-shaped structure, a polygon structure, and a ring structure.

26. The semiconductor IC of claim 21, wherein the clock distribution network includes a plurality of tree branches, wherein the pulse generator of the plurality of pulse generators is coupled to at least one tree branch of the plurality of tree branches, and wherein the clock signal is output to the at least one tree branch to the pulse generator.

27. The semiconductor IC of claim 21, wherein the clock distribution network includes a clock mesh having a plurality of mesh branches, wherein the pulse generator of the plurality of pulse generators is coupled to at least one mesh branch of the plurality of mesh branches, and wherein the clock signal is output to the plurality of mesh branches to the pulse generator.
